(19) United States
(12) Patent Application Publication
(10) Pub. No.: US 2019/0364922 A1
(43) Pub. Date: Dec. 5, 2019

(54) EFFERVESCENT COFFEE BEVERAGE

(71) Applicants: Azeema Latiff, Miami, FL (US); Khatoon Bibi Latiff, Miami, FL (US)

(72) Inventors: Azeema Latiff, Miami, FL (US); Khatoon Bibi Latiff, Miami, FL (US)

(21) Appl. No.: 16/136,114

(22) Filed: Sep. 19, 2018

Related U.S. Application Data
(60) Provisional application No. 62/680,433, filed on Jun. 4, 2018.

(51) Int. Cl. A23F 5/38; A23F 5/30; A23F 5/40; A23L 2/40; A23L 2/395; A23L 2/56

(52) U.S. Cl. CPC A23F 5/385; A23F 5/30; A23F 5/40; A23L 2/40; A23L 2/395; A23V 2300/31; A23V 2002/00; A23V 2250/2108; A23V 2250/032; A23V 2250/056; A23V 2300/20; A23L 2/56

(57) ABSTRACT

A coffee product is produced in the form of an effervescent tablet, typically in the shape of roasted coffee beans. The end-product, once the tablet is added to water, is an instant coffee having the aroma, flavor and taste of freshly brewed coffee, such as Arabica or Robusta coffee. The product will appeal to all senses—auditory, olfactory and have the visual effects of an effervescent tablet that can be made hot or cold. The product is convenient, easily accessible and done without the use of any machinery, apparatus or even electricity. This coffee product will create a new culture in the way people drink coffee nationally and globally.

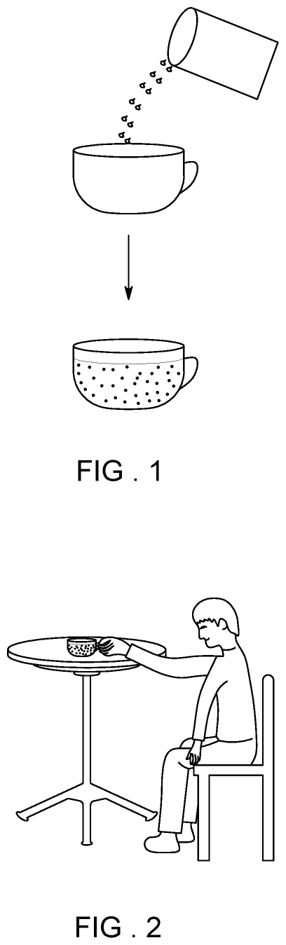

### BACKGROUND OF THE INVENTION

The present invention relates to beverages and, more specifically, to a coffee flavored beverage provided in an effervescent tablet form.

Coffee is a popular beverage about the world. Typical coffee is served hot or cold and is brewed by passing hot water over ground coffee beans. Current methods for making coffee include filtered coffee, drip coffee, cup-at-a-time machines, brewing coffee machines, Moka pot, expresso machines, percolated coffee, super automatic machines used in large chains, in-car coffee makers, machines that brew coffee using patented centrifugal technology to latest coffee technology using high tech devices for cold brew. All the of the methods mentioned are basically cooking appliances with some single cup delivery systems.

Limitations of these conventional systems include physically buying the appliances and accompanying products, such as pre-filled cups for the cup-at-a-time machines, filters for the brewing machines, the actual coffee or coffee beans, and the like. The cost of purchasing and use of these products over time can be very high. There is also the need of electricity and many of the methods and apparatus are not convenient in many parts of the world today. Keeping millions of people in developing countries from being able to enjoy a cup of coffee.

As can be seen, there is a need for improved methods for providing a coffee beverage to a consumer.

### SUMMARY OF THE INVENTION

In one aspect of the present invention, a effervescent coffee product comprising a coffee extract; and an effervescent couple, wherein the coffee extract and effervescent couple are combined into a tablet form.

In another aspect of the present invention, a method of providing a coffee beverage to a user comprising dissolving an effervescent coffee product in water, the effervescent coffee product comprising a coffee extract and an effervescent couple, wherein the coffee extract and effervescent couple are combined into a tablet form.

These and other features, aspects and advantages of the present invention will become better understood with reference to the following drawings, description and claims.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a coffee product that is produced in the form of an effervescent tablet, typically in the shape of roasted coffee beans. The end-product, once the tablet is added to water, is an instant coffee having the aroma, flavor and taste of freshly brewed coffee, such as Arabica or Robusta coffee. The product will appeal to all senses—auditory, olfactory and have the visual effects of an effervescent tablet that can be made hot or cold. The product is convenient, easily accessible and done without the use of any machinery, apparatus or even electricity. This coffee product will create a new culture in the way people drink coffee nationally and globally.

The coffee product of the present invention provides an overall functionality, convenience, simplicity and aesthetic design not currently available in the art. The coffee product can be made anywhere without the use of electricity or any machines or apparatus, and accessible to millions worldwide. This is a product that can be made by simply boiling water in a pot and pouring it into a cup and adding the effervescent coffee beans. Alternatively, cold or room temperature water may be used to product the coffee beverage by adding the effervescent coffee bean to any water-based sample. Of course, other liquids may be used to create a combination of flavors, depending on the selection of the base liquid. The effervescent coffee beans and the coffee beverage made therefrom can appeal to all senses olfactory the odor of fresh roasted coffee, can appeal to the taste buds with the taste of fresh brewed coffee, and can appeal visually seeing the fizz effect of the coffee beans as well as the auditory sound of the fizz. The effervescent coffee product can be packaged in small pouches that can produce the adequate moisture barrier needed. In some embodiments, the packaging can be formed to be ecofriendly and bio-degradable.

Various effervescent producing reagents may be used to create the coffee product of the present invention. While an exemplary formulation is provided below, various formulations may be contemplated within the scope of the present invention.

In one embodiment, an effervescent coffee product may be formed as a solid and may be formed with the following ingredients. Of course, changes, deletions and/or substitutions from the below are within the scope of the present invention.

The effervescent coffee product can include tartaric acid, citric acid and sodium bicarbonate in a ratio of about 2:1:4 by weigh to create the appropriate effervescent effect. This combination, also referred to as the effervescent couple, may be added to a freeze-dried coffee extract. In some embodiments, the solids used to prepare the self-dissolving effervescent composition can be pulverized below 1,000 microns and above 35 microns while the composition remains anhydrous or at least with less than about one percent water by weight.

The pulverized composition mixed using predetermined proportions by weight effervescent couple and coffee extract and then fed into a tablet machine. In some embodiments, the tablet machine can create a shape of coffee beans.

In some embodiments, the formulation of the present invention can use about 100 parts of coffee extract with an amount of the effervescent couple in the range of 26 to 36 parts, typically about 30 to 32 parts.

In some embodiments, the resulting tableted solids may be lightly roasted to bring out the aroma of fresh coffee beans.

While the above describes a coffee product using freeze-dried coffee extract, other solid flavors may be used in the embodiment of the present invention, such as decaffeinated coffee, tea and chocolate with the effervescent couple. Such products may be formed in a manner similar to that described above for the coffee extract.

In some embodiments, additional components may be added to the tablets prior to tableting. For example, sweetener, such as sugar or sugar substitute, and/or powdered cream may be added to the mixtures in suitable amounts.

The effervescent chemistry described above may be altered within the scope of the present invention to acquire the desired taste and visual fizz effect.

It should be understood, of course, that the foregoing relates to exemplary embodiments of the invention and that modifications may be made without departing from the spirit and scope of the invention as set forth in the following claims.

What is claimed is:

1. An effervescent coffee product comprising:
a coffee extract; and
an effervescent couple, wherein
the coffee extract and effervescent couple are combined into a tablet form.

2. The effervescent coffee product of claim 1, wherein the tablet form is shaped as a coffee bean.

3. The effervescent coffee product of claim 1, wherein the coffee extract is freeze-dried.

4. The effervescent coffee product of claim 1, wherein the coffee extract and effervescent couple are pulverized below 1,000 microns and above 35 microns.

5. The effervescent coffee product of claim 1, wherein the effervescent couple is formed from an organic acid and a base.

6. The effervescent coffee product of claim 5, wherein the organic acid includes at least one of tartaric acid and citric acid.

7. The effervescent coffee product of claim 5, wherein the base is sodium bicarbonate.

8. The effervescent coffee product of claim 1, further comprising at least one of a sweetener and a solid creamer.

9. A method of providing a coffee beverage to a user comprising:
dissolving an effervescent coffee product in water, the effervescent coffee product comprising a coffee extract and an effervescent couple, wherein the coffee extract and effervescent couple are combined into a tablet form.

10. The method of claim 9, further comprising shaping the tablet form in the shape of a coffee bean.

11. The method of claim 9, further comprising freeze-drying the coffee extract.

12. The method of claim 9, further comprising pulverizing the coffee extract and effervescent couple to an average size below 1,000 microns and above 35 microns.

13. The method of claim 9, wherein the effervescent couple is formed from an organic acid and a base.

14. The method of claim 13, wherein the organic acid includes at least one of tartaric acid and citric acid.

15. The method of claim 13, wherein the base is sodium bicarbonate.

16. The method of claim 13, further comprising adding at least one of a sweetener and a solid creamer to the coffee product.
